(19) United States
(12) Patent Application Publication
(10) Pub. No.: US 2020/0092625 A1
(43) Pub. Date: Mar. 19, 2020

(54) SMART DEVICE COVER

(71) Applicant: Hayes S. Raffle, Palo Alto, CA (US)

(72) Inventor: Hayes S. Raffle, Palo Alto, CA (US)

(21) Appl. No.: 16/570,552

(22) Filed: Sep. 13, 2019

Related U.S. Application Data
(60) Provisional application No. 62/730,815, filed on Sep. 13, 2018.

(51) Int. Cl. H04R 1/02; G10L 15/22

(52) U.S. Cl. CPC H04R 1/028; G10L 2015/088; G10L 15/22

(57) ABSTRACT

A cover for a smart speaker may include a body defining an interior cavity to be fitted over a smart speaker. A plurality of openings may be defined in the body of the cover. The plurality of openings may be positioned on the body so as to provide access to various input and/or output devices of the smart speaker on which the cover is fitted. The cover may also include features, such as facial features and the like associating the cover with a character. The cover may include an electronics module, providing for animation and/or illumination of the various features of the cover, output of audio content, and the like, triggered in response to detection of keywords, output content, and the like.

### CROSS-REFERENCE TO RELATED APPLICATION

This application claims priority to U.S. Provisional Patent Application No. 62/730,815, filed on Sep. 13, 2018, the disclosure of which is incorporated by reference herein in its entirety.

### FIELD

This relates, generally, to a cover for a smart device.

### BACKGROUND

Computing devices may provide for the exchange information, data and the like. Computing devices may include devices such as, for example, smart speakers, smartphones, tablet/convertible computing devices, and the like, as well as desktop computing devices, laptop computing devices, and other such devices. Computing devices may receive information via, for example, one or more user input devices such as, for example, audio input devices, touchscreen input devices, image input devices, manipulation devices, interface ports, wireless connections, and the like. Similarly, computing devices may output information via one or more output devices such as, for example, audio output devices, display devices, interface ports, wireless connections, and the like.

### SUMMARY

In one aspect, a cover include a body defining an interior cavity, the interior cavity being configured to receive a smart speaker therein, a first opening defined in the body, the first opening being configured to correspond to a user interface of the smart speaker, a plurality of features provided on an exterior of the body, and an electronics module. The electronics module may include at least one sensor configured to detect a user input, and at least one output device configured to output a response to the user input detected by the at least one sensor.

In some implementations, the plurality of features may define a character of the cover, the plurality of features including at least one of facial features of the character, ears of the character, arms of the character, or legs of the character.

In some implementations, the at least one sensor of the electronics module may include at least one of an audio sensor, an image sensor, or a contact sensor, and the at least one output device of the electronics module may include at least one of a motor, a light source, or an audio output device. In some implementations, the motor may be configured to animate at least one feature of the cover in response to the detected user input. In some implementations, the light source may be configured to illuminate a portion of the cover in response to the detected user input. In some implementations, the audio output device may be configured to output audio content in response to the detected user input.

In some implementations, the user input may be a keyword detected by the audio sensor of the electronics module, the keyword being associated with the cover, and, in response to the detection of the keyword by the audio sensor of the electronics module, the audio output device may be configured to output a wake word associated with the smart speaker. In some implementations, the light source may be configured to illuminate a portion of the cover during a delay period defined between detection of the keyword by the audio sensor to output of the wake word by the audio output device. In some implementations, the motor may be configured to animate one or more of the plurality of features of the cover during a delay period defined between detection of the keyword by the audio sensor to output of the wake word by the audio output device. In some implementations, the cover may include a switch operably coupled to the electronics module. The switch may provide for selection of an operation profile of the electronics module corresponding to the smart speaker received in the body of the cover.

In some implementations, a first opening in the cover may be configured to correspond to a user input interface and a user output interface of a smart speaker received in the body of the cover. A second opening defined in the body of the cover may be configured to correspond to an interface port of the smart speaker received in the body of the cover.

In another general aspect, a method of operating a cover for a smart speaker may include detecting, by one of a plurality of sensors of an electronics module of the cover, a user input triggering output by the electronics module, and outputting, by at least one output device of the electronics module, a cover output in response to the detected user input, including at least one of operating a motor of the electronics module and animating at least one feature of the cover in response to the detected user input, operating a light source of the electronics module and illuminating a portion of the cover in response to the detected user input, or operating an audio output device of the electronics module and outputting audio content in response to the detected user input.

In some implementations, the cover may correspond to a character, and operating the motor of the electronics module and animating at least one feature of the cover may include operating the motor and animating at least one of facial features of the cover, one or more ears of the cover, one or more arms of the cover, or one or more legs of the cover. In some implementations, detecting the user input may include detecting, in an audio signal captured by an audio sensor of the electronics module, a keyword associated with the cover, detecting, in an image captured by an image sensor of the electronics module, a gesture input, recognizing, in an image captured by the image sensor, an image of a user, or detecting, by a contact sensor of the electronics module, a contact input at one of a plurality of features of the cover. In some implementations, detecting the user input may include detecting, by an audio sensor of the electronics module of the cover, an audio user input, detecting a keyword associated with the cover in the audio user input, outputting the cover output in response to the detecting of the keyword in the audio user input. In some implementations, outputting the cover output in response to the detecting of the keyword in the audio user input may include outputting audio content including a wake word associated with a smart speaker received in the cover, the wake word enabling a listening mode of the smart speaker.

In some implementations, outputting the audio content including the wake word associated with the smart speaker received in the cover may include determining a delay period between the detection of the keyword in the audio user input and the outputting of the audio content including the wake word, outputting an indicator of the delay period, including at least one of operating the light source of the electronics module and illuminating the portion of the cover during the delay period, or operating the motor of the electronics module and animating the at least one feature of the cover during the delay period, determining that the delay period has elapsed, and suspending operation of the light source, or suspending operation of the motor, in response to the determination that the delay period has elapsed. In some implementations, outputting the audio content including the wake word associated with the smart speaker received in the cover may include determining a delay period between the detection of the keyword in the audio user input and the outputting of the audio content including the wake word, determining that the delay period has elapsed, and outputting an indicator in response to the determination that the delay period has elapsed, including at least one of operating the light source of the electronics module and illuminating the portion of the cover in response to the determination that the delay period has elapsed, or operating the motor of the electronics module and animating the at least one feature of the cover in response to the determination that the delay period has elapsed.

In some implementations, the method may include detecting a selection of an operation profile of the electronics module at a switch that is operably coupled to the electronics module, the operation profile corresponding to the smart speaker received in the cover, operating the electronics module in accordance with the selected operation profile.

In another general aspect, a cover may include a body defining an interior cavity, the interior cavity being configured to receive a smart speaker therein, a first opening defined in the body, the first opening being configured to correspond to a user interface of the smart speaker, and a plurality of features provided on an exterior of the body, the plurality of features defining a character of the cover. In some implementations, the plurality of features of the cover may include at least one of facial features of the character, ears of the character, arms of the character, or legs of the character. In some implementations, the cover may include an electronics module coupled to the body. The electronics module may be configured to at least one of animate at least some of the plurality of features in response to a detected triggering action, illuminate at least some of the plurality of features in response to the detected triggering action, or output audio content in response to the detected triggering action.

In some implementations, the electronics module may include at least one sensor, including at least one of an audio sensor configured to detect an audio input, an image sensor configured to detect a gesture input or recognize a facial image, or a pressure sensor configured to detect a pressure input. In some implementations, the electronics module may include at least one output device, including at least one of a motor configured to animate at least one of the plurality of features of the cover in response to a detected user input, a light source configured to illuminate a portion of the cover in response to the detected user input, or an audio output device configured to output audio content in response to the detected user input. In some implementations, the cover may include a second opening defined in the body, the second opening being configured to correspond to an interface port of the smart speaker.

The details of one or more implementations are set forth in the accompanying drawings and the description below. Other features will be apparent from the description and drawings, and from the claims.

### BRIEF DESCRIPTION OF THE DRAWINGS

FIGS. 1A-1E illustrate exemplary smart devices.

FIG. 2A illustrates an exemplary smart speaker, and FIG. 2B illustrates an exemplary cover for the exemplary smart speaker shown in FIG. 2A, in accordance with implementations described herein.

FIG. 2C is a block diagram of an exemplary electronics module of an exemplary cover for an exemplary smart speaker, in accordance with implementations described herein.

FIG. 3A illustrates an exemplary smart speaker, and FIG. 3B illustrates an exemplary cover for the exemplary smart speaker shown in FIG. 3A, in accordance with implementations described herein.

FIG. 4A illustrates an exemplary smart speaker, and FIG. 4B illustrates an exemplary cover for the exemplary smart speaker shown in FIG. 4A, in accordance with implementations described herein.

FIG. 5 is a flowchart of an operation of a cover for a smart speaker, in accordance with implementations described herein.

### DETAILED DESCRIPTION

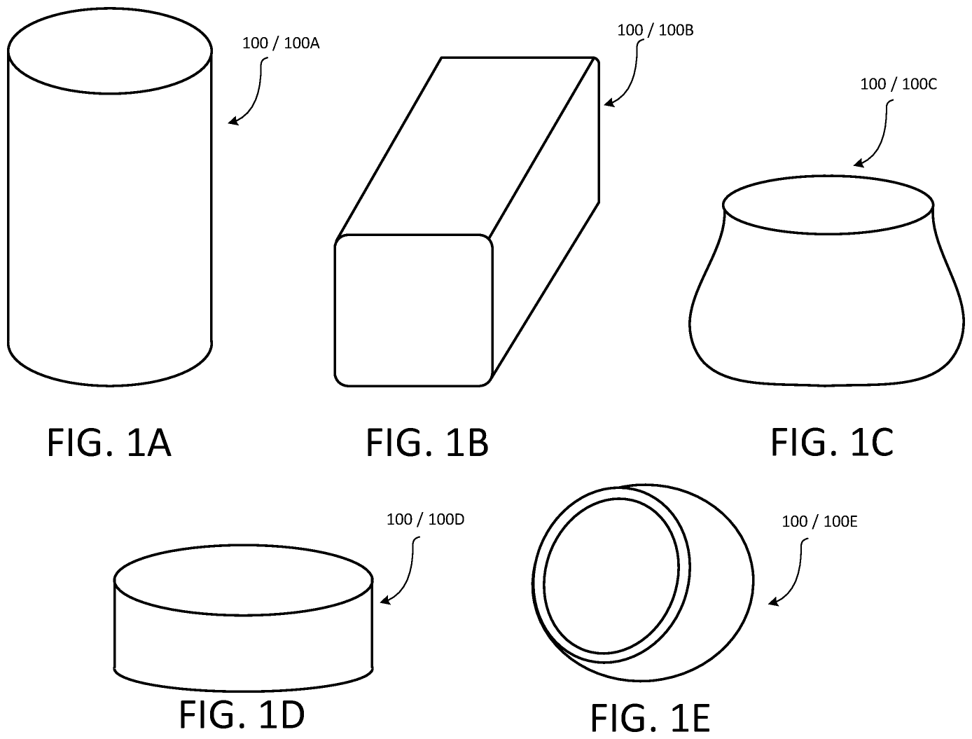

Smart devices may provide for access to internet services using a variety of different user command input modes, and may provide output in response to the user command inputs in a variety of different modes. Smart devices may also be connected to and/or communicate with other external devices to, for example, provide for control of external devices through input received by the smart device, exchange information with external devices, output information received from the external devices, and the like. Smart devices may include user interface devices such as, for example, a microphone for receiving voice inputs, a touch sensitive surface, manipulation devices/buttons and the like for receiving touch inputs, an image sensor, or camera, for receiving visual inputs, and the like. Smart devices may also include output devices such as, for example, one or more speakers for outputting audio output, a display, indicator lights, and the like for outputting visual output, and other such output devices. Smart devices may also include one or more interface ports providing for connection to an external power source (and for charging of an internal power storage device, or battery), for wired connection to external devices, and the like. Smart devices may be connected to a network, to facilitate communication with external devices via the network, to provide for access to internet services, via, for example, various different types of wireless connections, or a wired connection, and the like. Hereinafter, these types of smart devices may be referred to as “smart speakers,” simply for ease of discussion and illustration. However, as described above, such smart devices, or smart speakers, may include numerous different output devices, in addition to audio output devices, or speakers, as well as numerous different input devices. Exemplary smart devices 100A through 100E, or smart speakers 100A through 100E are illustrated in FIGS. 1 through 1E. Each of the exemplary smart devices 100A-100E may include one or more input devices, and one or more output devices, as described above. Smart devices 100, or smart speakers 100, may have other shapes and/or configurations, and may include different features and/or combinations of features.

Smart speakers 100 may be designed to operate, or interact with users, in a relatively human manner. For example, smart speakers may listen for and detect commands in natural spoken, colloquial language, and may output responses in natural, spoken, colloquial language. However, smart speakers 100, such as, for example, the exemplary smart speakers 100A-100E shown in FIGS. 1A-1E, may have a relatively utilitarian, or industrial, or appliance/furniture-like external appearance. This type of external appearance may result in an interactive experience that is less natural to the user, particularly when using natural language to request and receive information from the smart speaker. For example, in some situations, this type of external appearance may create the feeling that the user is conversing with an invisible person, or that the user is conversing with a disembodied character.

In some implementations, a decorative sock-type, or hand-type puppet may be fitted over the smart speaker, to provide a character, or face, with which the user may relate with the smart speaker for interaction. However, this type of covering may introduce usability issues. For example, this type of covering may obscure output devices such as displays, illuminated indicators, speakers and the like, and may impede user access to input devices such as microphones, touchscreens, manipulation devices, image sensors, and the like. In particular, this type of covering may compromise performance of the audio output device(s), or speaker(s) of the smart speaker, which may often be the primary output device of the smart speaker.

A smart speaker cover, in accordance with implementations described herein, may enhance user interaction with a smart speaker, while providing for unimpeded access to user input device(s) of the smart speaker, and while maintaining output functionality via user output device(s) of the smart speaker.

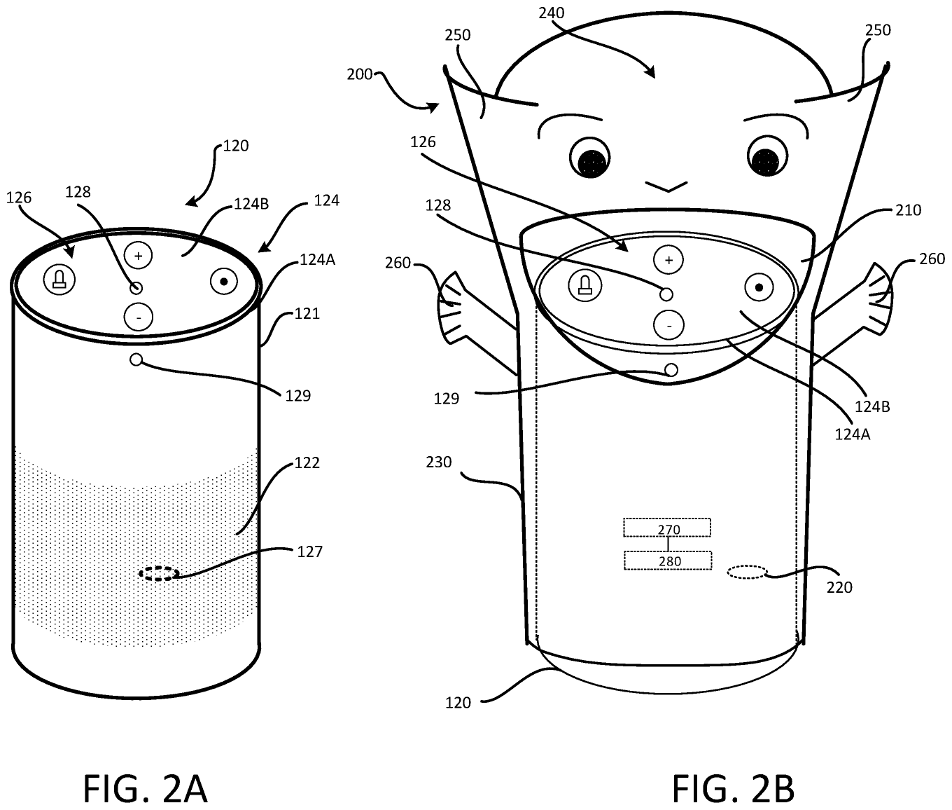

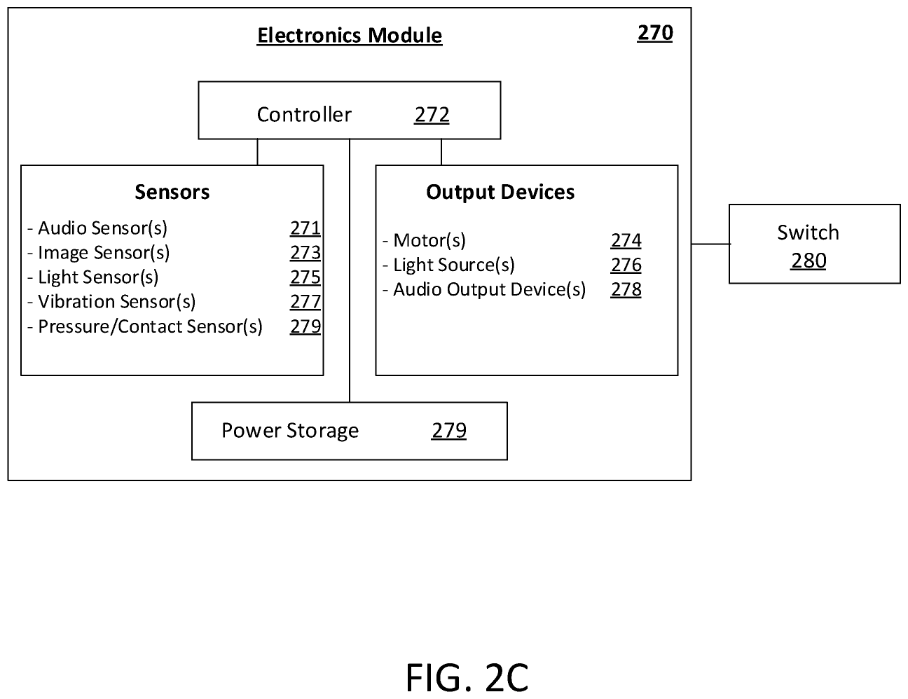

An exemplary smart speaker 120, and an exemplary cover 200 for the exemplary smart speaker 120, in accordance with implementations described herein, are shown in FIGS. 2A and 2B. As shown in FIGS. 2A and 2B, the exemplary smart speaker 120 may include a housing 121 in which an audio output device 122, or speaker 122, may be received. One or more visual output device(s) 124 may provide for visual output. For example, as shown in FIGS. 2A and 2B, in some implementations, the visual output device 124 may include one or more indicator lights 124A which may be selectively illuminated to, for example, indicate an operating state of the smart speaker 120 (i.e., an on/off state, a receiving state, or listening state, and the like). In some implementations, the visual output device 124 may include a display 124B, for displaying visual output to the user. The exemplary smart speaker 120 may also include a user input interface 126. The user input interface 126 may include, for example, an audio input device 128, or microphone 128, for receiving audio input commands from the user. In some implementations, the user input interface 126 may include a touch input surface 125 that can receive touch inputs. In some implementations, the display 124B and the touch input surface 125 may be included in a single touchscreen display device that can output visual information, and receive touch inputs. In some implementations, the user input interface 126 may include manipulation buttons, toggle switches, and other such user input devices. In some implementations, the smart speaker 120 may include a visual input device 129, or image sensor 129, or camera 129. The camera 129 may capture image input information for processing by the smart speaker 120. In some implementations, the smart speaker 120 may include one or more interface ports 127, to provide for connection of the smart speaker 120 to an external power source, an external device, and the like.

FIG. 2B illustrates the exemplary cover 200 positioned on the exemplary smart speaker 120 shown in FIG. 2A. The exemplary cover 200 may include a body 230 defining an internal cavity that may accommodate the external shape and/or contour of the smart speaker 120. The cover 200 may mask the relatively utilitarian, industrial external design of the smart speaker 120, while also preserving user access to the various user interface elements of the smart speaker 120, and not impeding the output of information from the smart speaker 120 to the user via the various output elements of the smart speaker 120. In some implementations, the cover 200 may be representative of a character. For example, in some implementations, the cover 200 may include facial features 240, ears 250, arms 260 and other such features on the body 230 of the cover 200. These features of the cover 200 may allow the user to associate a character, or a face, with the audio output, or voice, of the smart speaker 120. As users are conditioned to communicate while making eye contact with, for example, another person, a pet and the like, these features of the cover 200 may leverage natural conversational instincts, thus facilitating and enhancing user interaction with the smart speaker 120.

As shown in FIG. 2B, the body 230 of the cover 200 may be fitted over the housing 121 of the smart speaker 120. In some implementations, the body 230 may be made of a material that will allow audio output, or sound, emitted by the audio output device 122, or speaker 122, to transmit through the cover 200, relatively unimpeded. That is, the body 230 of the cover 200, or at least a portion of the body 230 that is to be positioned corresponding to the audio output device 122 of the smart speaker 120, may be made of a material that allows sound to be transmitted with little to no amplitude attenuation at different frequencies. For example, in some implementations, the body 230 may be made of a relatively loose weave polyester type fabric, or other material as appropriate.

A first opening 210 may be defined in the cover 200. In the exemplary arrangement shown in FIG. 2B, the first opening 210 may provide for physical and visual user access to the user input interface 126 and the visual output device(s) 124. That is, the first opening 210 may be positioned so as to allow for physical access to the various user manipulation devices, buttons, touch surfaces and the like included in the user input interface 126. Similarly, the first opening 210 may be positioned to allow the user to view the user input interface 126 and the visual indicator(s) 124. In the exemplary arrangement shown in FIG. 2B, the first opening 210 may also provide an unobstructed path for detection of audio inputs by the audio input device 128, or microphone 128 of the smart speaker 120. The first opening 210 may also provide for an unobstructed field of view for the visual input device 129, or image sensor 129, or camera 129, in capturing images. In some implementations, a second opening 220 may be defined in the cover 200. The second opening 220 may be positioned to provide for access to the one or more interface ports 127 of the smart speaker 120.

In some implementations, the cover 200 may include an electronics module 270. A block diagram of an exemplary electronics module, which may be included in cover for a smart device, in accordance with implementations described herein, is shown in FIG. 2C. The exemplary electronics module 270 may include, for example, a power storage device 279, or a battery 279. The exemplary electronics module may include one or more sensors, such as, for example audio sensors 271, image sensors 273, light sensors 275, vibration sensors 277, pressure and/or contact sensors 279, and other such sensors. The exemplary electronics module 270 may include output devices, including, for example, one or more motors 274, one or more light sources 276, one or more audio output devices 278, and other such components. A controller 272 may receive inputs detected by one or more of the sensors, and may control operation of one or more of the output devices in response to the inputs detected by the one or more sensors.

In some implementations, the electronics module 270 may provide for animation of various parts of the cover 200. For example, the electronics module 270 may control the one or more motors 274 to animate the facial features 240 and/or the ears 250 and/or the arms 260 of the exemplary cover 200 shown in FIG. 2B. Similarly, the electronics module 270 may control the one or more light sources 276 to illuminate portions of the cover 200, such as, for example, the facial features 240 of the cover 200, the opening 210 in the cover 200, an interior of the cover 200, and the like. In some implementations, the electronics module 270 may control the one or more audio output devices 278 to, for example, output an audible acknowledgment the to the user (such as, for example, a greeting to the user in response to detection of the user speaking the keyword/name of the cover 200). In some implementations, the electronics module 270 may control the audio output device(s) 278 to communicate with the smart speaker 120 based on, for example, audio input detected by the one or more audio sensors 271 of the electronics module 270. Animation and/or illumination of various parts of the cover 200, and/or audio output of the cover 200, in this manner may further facilitate and enhance natural user interaction with the cover 200, and, in turn, with the smart speaker 120

In some implementations, the operation of the electronics module 270 to control the one or more motor(s) 274 and/or the one or more light source(s) 276 and/or the one or more audio output device(s) 278 may be triggered in response to the detection of previously set keywords by one of the audio sensors of the electronics module 270. In some implementations, the operation of the electronics module 270 to control the one or more motor(s) 272 and/or the one or more light source(s) 276 and/or the one or more audio output device(s) 278 may be triggered in response to the detection of a pressure and/or contact input by the one or more pressure/contact sensors 279 of the electronics module 270. In some implementations, the operation of the electronics module 270 to control the one or more motors 274 and/or the one or more light source(s) 276 and/or the one or more audio output device(s) 278 may be triggered in response to the detection of a gesture input detected by the one or more image sensor(s) 273 of the electronics module 270. In some implementations, the operation of the electronics module 270 to control the one or more motor(s) 274 and/or the one or more light source(s) 276 and/or the one or more audio output device(s) 278 may be triggered in response to recognition in an image captured by the image sensor(s) 273, for example facial recognition. In some implementations, operation of the one or more motor(s) 274 and/or the one or more light source(s) 276 and/or the one or more audio output device(s) 278 may be triggered in response to recognition of any face in the images captured by the image sensor(s) 273. In some implementations, operation of the one or more motor(s) 274 and/or the one or more light source(s) 276 and/or the one or more audio output device(s) 278 may be triggered in response to recognition of the face of a specific user in the images captured by the image sensor(s) 273. In some implementations, operation of the electronics module 270 to control the one or more motors 274 and/or the one or more light source(s) 276 and/or the one or more audio output device(s) 278 may be triggered in response to certain other conditions, detected by one of the sensors of the electronics module 270.

In some implementations, the electronics module 270, for example, the audio sensor 271 of the electronics module 270, may detect, and recognize, the keyword that is, for example, spoken by the user within a detection range of the audio sensor 271 of the electronics module 270 of the cover 200. In response to this detection and recognition of the keyword/name, the electronics module 270 may, for example, control the one or more motor(s) 274 to animate one or more features of the cover 200, and/or may control the one or more light source(s) 276 to illuminate one or more portions of the cover 200. In some implementations, the electronics module 270, for example, the pressure/contact sensor(s) 279 of the electronics module 270, may detect a pressure/contact input at the cover 200. Exemplary pressure/contact inputs may include, for example, a squeeze detected of one of the hands/arms 260, or ears 250 of the cover 200, a tap at the body 230 of the cover 200, and the like. In response to the detected pressure/contact input, the electronics module 270 may, for example, control the one or more motor(s) 274 to animate one or more features of the cover 200, and/or may control the one or more light source(s) 276 to illuminate one or more portions of the cover 200. Animation and/or illumination of the cover 200 in this manner, for example, without user initiation and/or specific user intervention, may further facilitate and enhance user interaction with the cover 200, and in turn with the smart speaker 120, in a relatively natural, comfortable manner.

In some implementations, the cover 200 may respond to a keyword that corresponds to its character such as, for example, a name, its facial features, and the like. In some implementations, the keyword for the cover 200 may be previously set. That is, in some implementations, the cover 200 may be provided to the user with the keyword already set, or with the cover 200 already named. In some implementations, the user may set, or reset, the keyword for the cover 200 based on user preferences. In setting the keyword, the user may, for example, speak the desired keyword, or name, for detection by one of the audio sensor(s) 271 of the cover 200, to train the audio sensor(s) 271 of the electronics module 270 to listen for and detect the keyword, or name of the cover 200 spoken by the user. In some situations, setting, or resetting, the keyword, or name, in this manner may allow the interaction to be personalized for a specific user. That is, setting/resetting the keyword/name in this manner may cause the cover 200 to respond (i.e., the electronics module 270 to control the motor(s) 274 and/or the light source(s) 276 to animate and/or illuminate the cover 200, and/or the audio output device(s) 278 to output audio content, as described above) only when the keyword/name is spoken by the specific user. In some implementations, the keyword/name may be set/reset in response to text entered by the user, and translated into the keyword/name to be detected by the electronics module 270 of the cover 200.

In some implementations, the smart speaker 120 may have a keyword, or wake word, that, for example, activates a listening mode of the smart speaker 120. In some circumstances, the keyword/name associated with the cover 200 may not be the same as the wake word associated with the smart speaker 120. In this situation, a user speaking the keyword/name of the cover 200 may cause the cover 200 to animate/illuminate as described above, but will not cause the smart speaker 120 to initiate the listening mode, in which the smart speaker 120 can receive user input and/or commands, and respond to, or execute, the received user input and/or commands. Rather, in this situation, the user will have to separately speak the wake word associated with the smart speaker 120 in order to activate the listening mode of the smart speaker. This may detract from the relatively natural user interaction with the smart speaker 120 provided by the response of the cover 200 to detection of the keyword/name of the cover 200 (i.e., animation or illumination of the cover 200 and/or audio content output in response to detection of the keyword/name of the cover 200 as described above).

In some implementations, detection of a user input (i.e., an audio input such as the keyword/name of the cover 200 detected by the audio sensor(s) 271, a contact/pressure input detected by the contact/pressure sensor(s) 279, a gesture input detected by the image sensor(s) 273, facial recognition in images captured by the images sensor(s) 273) may trigger the electronics module 270 to control the audio output device(s) 278 to output the wake word of the smart speaker 120, to initiate the listening mode of the smart speaker 120. For example, in some implementations, the electronics module 270 may control the audio output device(s) 278 to speak the wake word of the smart speaker 120, in response to detection of the keyword, or name of the cover 200.

In some implementations, in response to detection of the user speaking the keyword/name of the cover 200, the audio output device 278 of the cover 200 may output the wake word of the smart speaker 120, so that the audio output of the wake word of the smart speaker 120 is only detected by the audio input device 128, or speaker 128, of the smart speaker 120. This may allow the user to maintain the relatively natural interaction with the cover 200 of the smart speaker 120, while also allowing the user to input commands to the smart speaker 120 for execution, thus enhancing the user's overall experience with the smart speaker 120.

In some implementations, there may be a delay between when the keyword/name of the cover 200 is spoken, and when the listening mode of the smart speaker 120 is initiated/active. That is, there may be a delay between when the keyword/name of the cover 200 is detected/the audio output device 278 of the cover 200 outputs the wake word of the smart speaker 120, and when the audio input device 128 of the smart speaker 120 detects the wake word and initiates the listening mode. In some implementations, the cover 200 may output an indicator of the delay period to the user. For example, in a first mode of operation, the electronics module 270 may control the motor(s) 274 and/or the light source(s) 276 to animate and/or illuminate the cover 200 during the delay period, until the listening mode of the smart speaker 120 is enabled. In the first mode of operation, the termination of the animation and/or illumination of the cover 200 may provide an indication to the user that the listening mode of the smart speaker is enabled. In a second mode of operation, the electronics module 270 may control the motor(s) 274 and/or the light source(s) 276 to animate and/or illuminate the cover 200 after the delay period has elapsed and the listening mode of the smart speaker 120 has been enabled. In the second mode of operation, the initiation of the animation and/or illumination of the cover 200 may provide an indication to the user that the listening mode of the smart speaker is enabled. In some implementations, the delay period may include a previously set period of time (after detection of the keyword/name of the cover 200 triggering output of the wake word of the smart speaker 120 by the audio output device 278 of the cover 200), corresponding to the particular smart speaker 120, and an associated period of time for initiating the listening mode after detection of the wake word of the smart speaker 120.

In some implementations, the electronics module 270 may, essentially, control the components of the electronics module 270 of the cover 200 in the first mode of operation in response to detected inputs (i.e., detection of the keyword/name of the cover 200) that trigger action by, or operation of, the motor(s) 274 and/or the light sources 276 to animate and/or illuminate the cover 200, and/or that trigger action by, or operation of, the audio output device(s) 278 to output audio content, in response to the detected user inputs. In this situation, the electronics module 270 may control operation of the various output devices of the cover 200 for a set period of time, that may be previously set, or may be set, or reset, by the user based on user preferences.

In some implementations, the cover 200 may include a switch 280, for example, in communication with the electronics module 270. In some implementations, the cover 200 may be switchable, to accommodate multiple different types of smart speakers having different wake words. For example, in some implementations, the switch 280 may allow the user to select an operating profile for the electronics module 270/the cover 200. The operating profile may be based on, for example, the type of smart speaker (and associated wake word) on which the cover 200 is fitted.

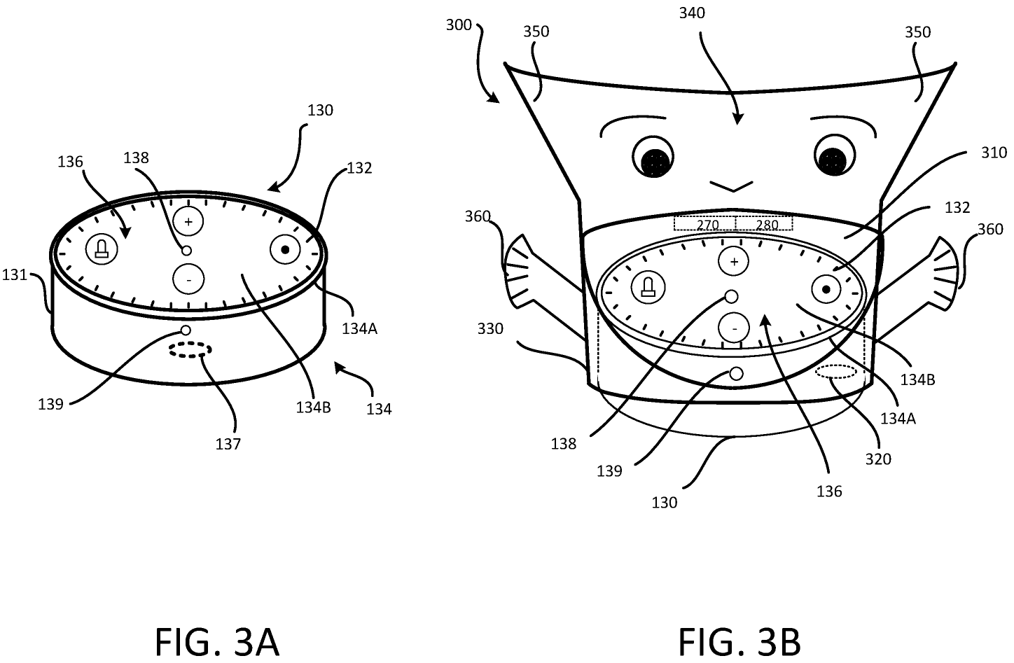

An exemplary smart speaker 130, and an exemplary cover 300 for the exemplary smart speaker 130, in accordance with implementations described herein, are shown in FIGS. 3A and 3B. As shown in FIGS. 3A and 3B, the exemplary smart speaker 130 may include a housing 131 in which an audio output device 132, or speaker 132 may be received. One or more visual output device(s) 134 may provide for visual output. In the exemplary smart speaker 130 shown in FIGS. 3A and 3B, the visual output device(s) 134 includes indicator lights 134A which may be selectively illuminated to, for example, indicate an operating state of the smart speaker 130 (i.e., an on/off state, a receiving, or listening state, and the like). In some implementations, the visual output device 134 may include a display 134B, for displaying visual output to the user. The exemplary smart speaker 130 may also include a user input interface 136. The user input interface 136 may include, for example, an audio input device 138, or microphone 138, for receiving audio input commands from the user. In some implementations, the user input interface 136 may include a touch input surface 135 for receiving touch inputs from the user. In some implementations, a touchscreen display device may provide the touch input surface 135 for receiving user input, and the display 134B for providing visual output. In some implementations, the user input interface may include other manipulation buttons, toggle switches, and other such user input devices. In some implementations, the smart speaker 130 may include a visual input device 139, or image sensor 139, or camera 139. The camera 139 may capture image input information for processing by the smart speaker 130. In some implementations, the smart speaker 130 may include one or more interface ports 137, to provide for connection to an external power source, an external device, and the like.

FIG. 3B illustrates the exemplary cover 300 positioned on the exemplary smart speaker 130 shown in FIG. 3A. The exemplary cover 300 may include a body 330 defining an internal cavity that may accommodate the external shape and/or contour of the exemplary smart speaker 130. The cover 300 may mask the relatively utilitarian, industrial external design of the smart speaker 130, while also preserving user access to the various user interface elements of the smart speaker 130, and not impeding the output of information to the user via the various output elements of the smart speaker 130. As with the exemplary cover 200 shown in FIG. 2B, in some implementations, the cover 300 may be representative of a character, including, for example, facial features 340, ears 350, arms 360 and the like provided on the body 330 of the cover 300. These features of the cover 300 may allow the user to associate a character, or a face, with the audio output, or voice, of the smart speaker 130, make eye contact with the character, and the like, thus leveraging natural conversational instincts, and facilitating/enhancing user interaction with the smart speaker 130.

A first opening 310 may be defined in the cover 300. The first opening 310 may provide for physical and visual user access to the user input interface 136 and the visual output device(s) 134. That is, the first opening 310 may be positioned so as to allow for physical access to the various user manipulation devices, buttons, touch surfaces and the like included in the user input interface 136, and also to allow the user to view the user input interface 136 and the visual indicator(s) 134. In the exemplary arrangement shown in FIG. 3B, the first opening 310 may also provide an unobstructed path for detection of audio inputs by the audio input device 138, or microphone 138 of the smart speaker 130. The first opening 310 may also maintain output functionality for sound from the audio output device 132, or speaker 132. The first opening may also provide for an unobstructed field of view for the visual input device 139, or image sensor 139, or camera 139. In some implementations, a second opening 320 may be defined in the cover 300 to provide for access to the one or more interface ports 137 of the smart speaker 130.

In some implementations, the cover 300 may include an electronics module such as the exemplary electronics module 270 described above in detail with respect to FIGS. 2B and 2C. In some implementations, the cover 300 may also include a switch 280, in communication with the electronics module 270, as described above in detail with respect to FIGS. 2B and 2C The electronics module 270 may provide for animation and/or illumination of various parts of the cover 300 as described above with respect to the cover 200 in FIG. 2B, further facilitating and enhancing user interaction with the smart speaker 130. In some implementations, this operation of the electronics module 270 to control the cover 300 may be triggered by user inputs including, for example, detection of certain keywords/names (detected by the one or more audio sensor(s) 271 of the electronics module 270), gesture inputs (detected by the one or more image sensor(s) 273 of the electronics module 270), facial recognition (in images captured by the image sensor(s) 273), pressure/contact inputs (detected by the one or more pressure/contact sensor(s) 279 of the electronics module 270), and other such inputs and/or conditions, to further facilitate and enhance user interaction with the smart speaker 130 in a relatively natural, comfortable manner.

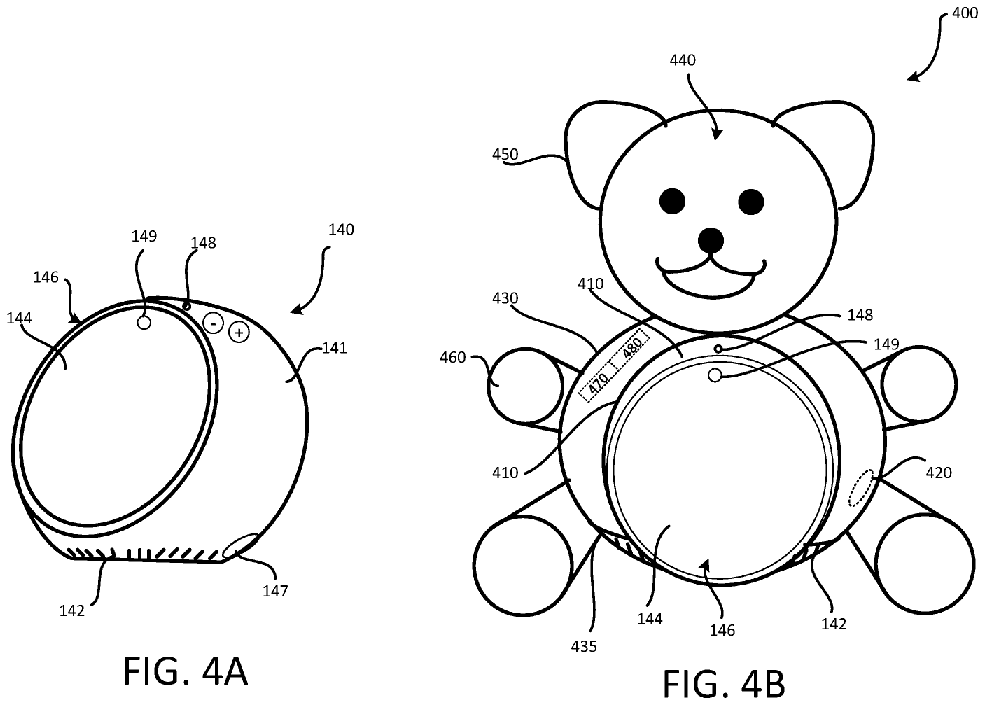

An exemplary smart speaker 140, and an exemplary cover 400 for the exemplary smart speaker 140, in accordance with implementations described herein, are shown in FIGS. 4A and 4B. As shown in FIGS. 4A and 4B, the exemplary smart speaker 140 may include a housing 141 in which an audio output device 142, or speaker 142 may be received. In some implementations, a user interface 146 of the smart speaker 140 may include a display 144, for example, a touchscreen display 144. In this exemplary arrangement, the touchscreen display 144 may provide for visual output of information to the user, and may also receive user inputs, or touch inputs, for processing by the smart speaker 140. In some implementations, the smart speaker 140 may include indicator lights which may be selectively illuminated to output visual indicators to the user. In some implementations, the user interface 146 may include, for example, an audio input device 148, or microphone 148, for receiving audio input commands from the user. In some implementations, the user input interface 146 may include manipulation buttons, toggle switches, and other such input devices. In some implementations, the smart speaker 140 may include a visual input device 149, or image sensor 149, or camera 149. The camera 149 may capture image input information for processing by the smart speaker 140. In some implementations, the smart speaker 140 may include one or more interface ports 147, to provide for connection to an external power source, an external device, and the like.

FIG. 4B illustrates the exemplary cover 400 positioned on the exemplary smart speaker 140 shown in FIG. 4A. The exemplary cover 400 may include a body 430 defining an internal cavity that may accommodate the external shape and/or contour of the smart speaker 140. As with the exemplary cover 200 illustrated in FIG. 2B, and the exemplary cover 300 illustrated in FIG. 3B, the cover 400 may mask the relatively utilitarian, industrial external design of the smart speaker 140, while also preserving user access to the various user interface elements of the smart speaker 140, and not impeding the output of information to the user via the various output elements of the smart speaker 140. As with the exemplary cover 200 shown in FIG. 2B and the exemplary cover 300 shown in FIG. 3B, in some implementations, the cover 400 may be representative of a character, including, for example, facial features 440, ears 450, arms 460 and the like provided on the body 430 of the cover 400. These features of the cover 400 may allow the user to associate a character, or a face, with the audio output, or voice, of the smart speaker 430, make eye contact with the character, and the like, thus leveraging natural conversational instincts, and facilitating/enhancing user interaction with the smart speaker 140.

A first opening 410 may be defined in the cover 400. The first opening 410 may provide for physical and visual user access to the user interface 146 of the smart speaker 140. That is, the first opening 410 may be positioned so as to allow the user to view the touchscreen display 144 and any other visual indicators of the smart speaker 140, and also to physically access the touchscreen display 144 for entry of touch inputs. In the exemplary arrangement shown in FIG. 4B, the first opening 410 may also provide an unobstructed path for detection of audio inputs by the audio input device 148, or microphone 148 of the smart speaker 140. The first opening 410 may also provide for an unobstructed field of view for the visual input device 149, or image sensor 149, or camera 149 in capturing images. In some implementations, a second opening 420 may be defined in the cover 300 to provide for access to the one or more interface ports 147 of the smart speaker 140. An open bottom end portion 435 of the body 430 of the cover 400, together with the material of the cover 400, may provide a path for the transmission of sound, output by the audio output device 142, or speaker 142.

In some implementations, the cover 400 may include an electronics module, such as the exemplary electronics module 270 described above in detail with respect to FIGS. 2B, 2C and 3B. In some implementations, the cover 400 may also include a switch 280, in communication with the electronics module 270, as described above in detail with respect to FIGS. 2B, 2C and 3B. The electronics module 270 may provide for animation and/or illumination of various parts of the cover 400 as described above with respect to the cover 200 shown in FIG. 2B and the cover 300 shown in FIG. 3B, further facilitating and enhancing user interaction with the smart speaker 140. In some implementations, this operation of the electronics module 270 to control the cover 300 may be triggered by user inputs including, for example, detection of certain keywords/names (detected by the one or more audio sensor(s) 271 of the electronics module 270), gesture inputs (detected by the one or more image sensor(s) 273 of the electronics module 270), facial recognition (in images captured by the image sensor(s) 273), pressure/contact inputs (detected by the one or more pressure/contact sensor(s) 279 of the electronics module 270), and other such inputs and/or conditions, to further facilitate and enhance user interaction with the smart speaker 140 in a relatively natural, comfortable manner.

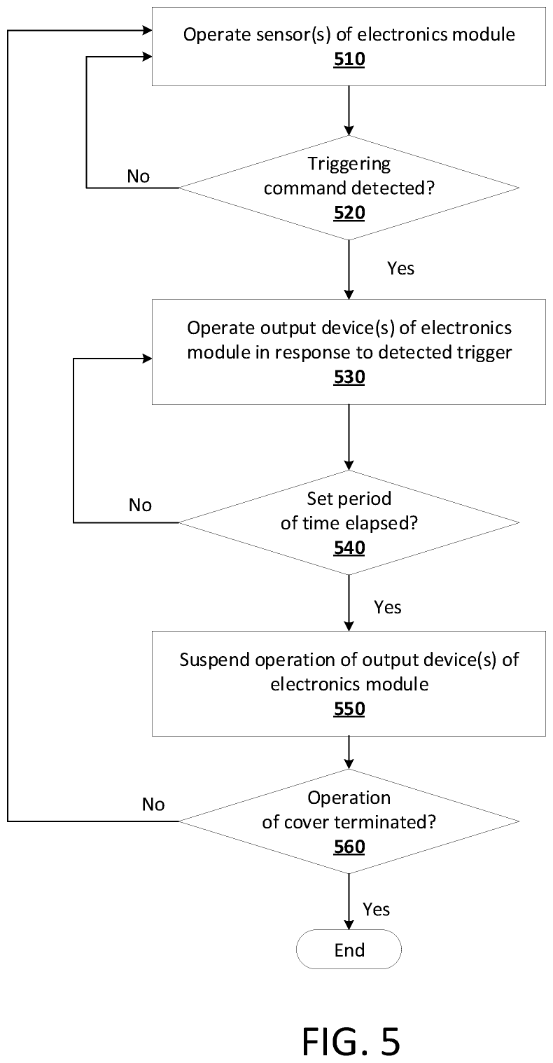

A flowchart of the operation of a cover including an electronics module, in accordance with implementations described herein, is shown in FIG. 5. The sensors (i.e., the audio sensor(s) and/or the image sensor(s) and/or the light sensor(s) and/or the vibration sensor(s) and/or the pressure/contact sensor(s)) of the electronics module may operate to detect user inputs. As noted above, the user inputs may include, for example, audio inputs, contact/pressure inputs, gesture inputs, facial recognition, and the like, that trigger operation of output device(s) of the electronics module. In response to detection of a user input corresponding to a triggering action (block 520), the electronics module may operate one or more of the output device(s), as detailed above with respect to FIGS. 2A through 4B. In particular, motor(s) and/or light source(s) of the electronics module may animate and/or illuminate the cover for a set period of time, and/or output audio content. Operation of the motor(s) and/or the light source(s) and/or audio output device(s) in this manner may serve to acknowledge, or serve as an indicator of the detected user input. Operation of the motor(s) and/or the light source(s) and/or audio output device(s) in this manner may be carried out during a delay period (corresponding to the set period of time), during which the cover communicates a wake word to the smart speaker to enable a listening mode of the smart speaker. After the set period of time has elapsed (block 540), operation of the output device(s) may be suspended (block 550). The process may continue until it is determined that the cover is no longer in an operational state (block 560).

The covers for smart speakers described above with respect to FIGS. 2A through 4B are merely exemplary in nature, and a cover for a smart speaker, in accordance with implementations described herein, may have numerous different configurations. For example, an internal configuration of a cover for a smart speaker, in accordance with implementations described herein, may be tailored to correspond to the external features of a particular smart speaker. A cover for a smart speaker, in accordance with implementations described herein may take the form of numerous different types of characters. A cover for a smart speaker, in accordance with implementations described herein, may have more openings, or fewer openings, in various different arrangements, to provide physical and visual access to the user interface and/or output elements of the smart speaker to which the cover is fitted.

Further, the covers for smart speakers described above with respect to FIGS. 2A through 4B are configured to accommodate the exemplary smart speakers, and the components of the exemplary smart speakers, shown in FIGS. 2A through 4B. As previously noted, a cover for a smart speaker, in accordance with implementations described herein, may be configured to accommodate smart speakers being equipped differently from the exemplary smart speakers described above. That is, an exemplary smart speaker may include other types of sensors, receiving devices, transmitting devices, and the like, not specifically described above with respect to FIGS. 2A through 4B. For example, a smart speaker may include thermal sensors, proximity sensors, infrared sensors (for example, transmitters and/or receivers), electromagnetic sensors (for example, transmitters and/or receivers), and the like. These types of sensors may, for example, detect the approach and/or presence of a user, the proximity of a user, a gesture implemented by the user, facial recognition of the user, and the like. Detection of the approach and/or presence and/or proximity of a user, facial recognition, and/or detection of a particular gesture, may, for example, trigger operation of the electronics module, for animation and/or illumination of the cover in a particular, appropriate manner for the detected condition. Accordingly, a cover for a smart speaker, in accordance with implementations described herein, may be configured to accommodate the operation and functionality of other types of sensors not specifically illustrated in FIGS. 2A through 4B. For example, in some implementations, a cover for a smart speaker, in accordance with implementations described herein, may include openings therein, corresponding to the positioning of these sensors on the smart speaker, to accommodate the operation and functionality of the sensors. In some implementations, a cover for a smart speaker, in accordance with implementations described herein, may be made of a material that will allow for the proper operation and/or functionality of these types of sensors, even when the sensors are covered, or partially covered, by a portion of the cover.

A cover for a smart speaker, in accordance with implementations described herein, may associate characteristics such as, for example, a face, a name, a character and the like, with the smart speaker, and in particular, with the audio output, or voice, of the smart speaker. These characteristics may facilitate user interaction with the smart speaker in a relatively natural, colloquial, conversational manner. This interaction between the user and the smart speaker may be further enhanced through animation and/or illumination of the features of the cover by the electronics module, as this animation and/or illumination may be triggered in response to recognized keywords, particular audio and/or visual output, and the like, without specific user initiation or intervention. The physical configuration of a cover for a smart speaker, in accordance with implementations described herein, allow for this improved user interaction with the smart speaker, while also providing unimpeded physical and visual access to the user interface devices and output devices of the smart speaker.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A cover, comprising:
a body defining an interior cavity, the interior cavity being configured to receive a smart speaker therein;
a first opening defined in the body, the first opening being configured to correspond to a user interface of the smart speaker;
a plurality of features provided on an exterior of the body; and
an electronics module, including:
at least one sensor configured to detect a user input; and
at least one output device configured to output a response to the user input detected by the at least one sensor.

2. The cover of claim 1, wherein the plurality of features defines a character of the cover, the plurality of features including at least one of:
facial features of the character;
ears of the character;
arms of the character; or
legs of the character.

3. The cover of claim 1, wherein
the at least one sensor of the electronics module includes at least one of:
an audio sensor;
an image sensor; or
a contact sensor; and
the at least one output device of the electronics module includes at least one of
a motor;
a light source; or
an audio output device.

4. The cover of claim 3, wherein, at least one of
the motor is configured to animate at least one feature of the cover in response to the detected user input;
the light source is configured to illuminate a portion of the cover in response to the detected user input; or
the audio output device is configured to output audio content in response to the detected user input.

5. The cover of claim 3, wherein
the user input is a keyword detected by the audio sensor of the electronics module, the keyword being associated with the cover, and
in response to the detection of the keyword by the audio sensor of the electronics module, the audio output device is configured to output a wake word associated with the smart speaker.

6. The cover of claim 5, wherein the light source is configured to illuminate a portion of the cover during a delay period defined between detection of the keyword by the audio sensor to output of the wake word by the audio output device.

7. The cover of claim 5, wherein the motor is configured to animate one or more of the plurality of features of the cover during a delay period defined between detection of the keyword by the audio sensor to output of the wake word by the audio output device.

8. The cover of claim 3, further comprising a switch operably coupled to the electronics module, wherein the switch provides for selection of an operation profile of the electronics module corresponding to the smart speaker received in the body of the cover.

9. The cover of claim 1, wherein the first opening is configured to correspond to a user input interface and a user output interface of the smart speaker received in the body of the cover, and wherein the cover includes a second opening defined in the body of the cover, the second opening being configured to correspond to an interface port of the smart speaker received in the body of the cover.

10. A method of operating a cover for a smart speaker, comprising:
detecting, by one of a plurality of sensors of an electronics module of the cover, a user input triggering output by the electronics module;
outputting, by at least one output device of the electronics module, a cover output in response to the detected user input, including at least one of:
operating a motor of the electronics module and animating at least one feature of the cover in response to the detected user input;
operating a light source of the electronics module and illuminating a portion of the cover in response to the detected user input; or
operating an audio output device of the electronics module and outputting audio content in response to the detected user input.

11. The method of claim 10, wherein the cover corresponds to a character, and wherein operating the motor of the electronics module and animating at least one feature of the cover includes operating the motor and animating at least one of facial features of the cover, one or more ears of the cover, one or more arms of the cover, or one or more legs of the cover.

12. The method of claim 10, wherein detecting the user input includes at least one of:
detecting, in an audio signal captured by an audio sensor of the electronics module, a keyword associated with the cover;
detecting, in an image captured by an image sensor of the electronics module, a gesture input;
recognizing, in an image captured by the image sensor, an image of a user; or
detecting, by a contact sensor of the electronics module, a contact input at one of a plurality of features of the cover.

13. The method of claim 10, wherein detecting the user input includes:
detecting, by an audio sensor of the electronics module of the cover, an audio user input;
detecting a keyword associated with the cover in the audio user input;
outputting the cover output in response to the detecting of the keyword in the audio user input.

14. The method of claim 13, wherein outputting the cover output in response to the detecting of the keyword in the audio user input includes outputting audio content including a wake word associated with a smart speaker received in the cover, the wake word enabling a listening mode of the smart speaker.

15. The method of claim 14, wherein outputting the audio content including the wake word associated with the smart speaker received in the cover includes:
determining a delay period between the detection of the keyword in the audio user input and the outputting of the audio content including the wake word;
outputting an indicator of the delay period, including at least one of:
operating the light source of the electronics module and illuminating the portion of the cover during the delay period; or
operating the motor of the electronics module and animating the at least one feature of the cover during the delay period;
determining that the delay period has elapsed; and
suspending operation of the light source, or suspending operation of the motor, in response to the determination that the delay period has elapsed.

16. The method of claim 14, wherein outputting the audio content including the wake word associated with the smart speaker received in the cover includes:
determining a delay period between the detection of the keyword in the audio user input and the outputting of the audio content including the wake word;
determining that the delay period has elapsed; and
outputting an indicator in response to the determination that the delay period has elapsed, including at least one of:
operating the light source of the electronics module and illuminating the portion of the cover in response to the determination that the delay period has elapsed; or
operating the motor of the electronics module and animating the at least one feature of the cover in response to the determination that the delay period has elapsed.

17. The method of claim 10, further comprising:
detecting a selection of an operation profile of the electronics module at a switch that is operably coupled to the electronics module, the operation profile corresponding to the smart speaker received in the cover; and
operating the electronics module in accordance with the selected operation profile.

18. A cover, comprising:
a body defining an interior cavity, the interior cavity being configured to receive a smart speaker therein;
a first opening defined in the body, the first opening being configured to correspond to a user interface of the smart speaker; and
a plurality of features provided on an exterior of the body, the plurality of features defining a character of the cover.

19. The cover of claim 18, wherein the plurality of features of the cover includes at least one of:
facial features of the character;
ears of the character;
arms of the character; or
legs of the character.

20. The cover of claim 18, further comprising an electronics module coupled to the body, wherein the electronics module is configured to at least one of:
animate at least some of the plurality of features in response to a detected triggering action;
illuminate at least some of the plurality of features in response to the detected triggering action; or
output audio content in response to the detected triggering action.

21. The cover of claim 20, wherein the electronics module includes:
at least one sensor, including at least one of:
an audio sensor configured to detect an audio input;
an image sensor configured to detect a gesture input or recognize a facial image; or
a pressure sensor configured to detect a pressure input; and
at least one output device, including at least one of
a motor configured to animate at least one of the plurality of features of the cover in response to a detected user input;
a light source configured to illuminate a portion of the cover in response to the detected user input; or
an audio output device configured to output audio content in response to the detected user input.

22. The cover of claim 18, further comprising a second opening defined in the body, the second opening being configured to correspond to an interface port of the smart speaker.
